(19) United States
(12) Patent Application Publication
(10) Pub. No.: US 2005/0148363 A1
(43) Pub. Date: Jul. 7, 2005

(54) Mobile telephone with detachable audio/speaking unit

(75) Inventors: Michael Kiessling, Freising (DE); Mirko Wolle, Dortmund (DE)

Correspondence Address: HITT GAINES, PC;AGERE SYSTEMS INC., PO BOX 832570, RICHARDSON, TX, 75083, US

(73) Assignee: Agere Systems, Incorporated, Allentown, PA (US)

(21) Appl. No.: 10/751,578

(22) Filed: Jan. 5, 2004

(51) Int. Cl. H04M 1/00

(52) U.S. Cl. 455/556.1

(57) ABSTRACT

A communication subscriber device and an audio/speaking unit adapted for use with a conventional subscriber basic unit, such as a mobile telephone. In one embodiment, the communication subscriber device includes: (1) a subscriber basic unit and (2) an audio/speaking unit, detachably interengageable with the subscriber basic unit, that provides audio and speaking functionality for the subscriber basic unit.

### TECHNICAL FIELD OF THE INVENTION

The present invention is directed, in general, to a communication subscriber device and, more specifically, to a mobile telephone and such unit suitable to be used for a communication subscriber device.

### BACKGROUND OF THE INVENTION

Often, a communication subscriber device comprising an audio unit, such as a mobile telephone, should or has to be used with an additional hands-free kit or a headset, for example when driving a car.

However, conventional additional headsets for communication subscriber devices, in particular for mobile telephones, are often forgotten or lost.

Moreover, if a separate battery is integrated within the headset, in particular in case the headset is designed as a wireless headset, such battery or accumulator may be discharged when the headset is needed for a call. In addition, usually two separated chargers are necessary, one for the communication subscriber device and one for the headset, due to there respective specific designs or merely for the convenience of charging both of the two separate devices at the same time.

What is needed in the art is an improved communication subscriber device that does not suffer from such disadvantages.

### SUMMARY OF THE INVENTION

To address the above-discussed deficiencies of the prior art, the present invention provides a communication subscriber device and an audio/speaking unit adapted for use with a conventional subscriber basic unit, such as a mobile telephone. In one embodiment, the communication subscriber device includes: (1) a subscriber basic unit and (2) an audio/speaking unit, detachably interengageable with the subscriber basic unit, that provides audio and speaking functionality for the subscriber basic unit.

In another aspect, the present invention provides an audio/speaking unit adapted for use with a conventional subscriber basic unit. In one embodiment, the audio/speaking unit includes: (1) a mechanical interface configured to allow the audio/speaking unit to be detachably interengageable with a subscriber basic unit, (2) an electrical interface configured to communicate with the subscriber basic unit and (3) a microphone and a loudspeaker coupled to the electrical interface and configured to provide audio and speaking functionality for the subscriber basic unit.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic view of a mobile telephone having a detachable audio/speaking unit according to the invention;

FIG. 2 illustrates a schematic exploded view of the mobile telephone according to FIG. 1 but with the audio/speaking unit detached; and

FIGS. 3 and 4 together illustrate schematic views of the rear side of a detached audio/speaking unit representing kinds of clips for using the detachable audio/speaking unit as an headset.

### DETAILED DESCRIPTION

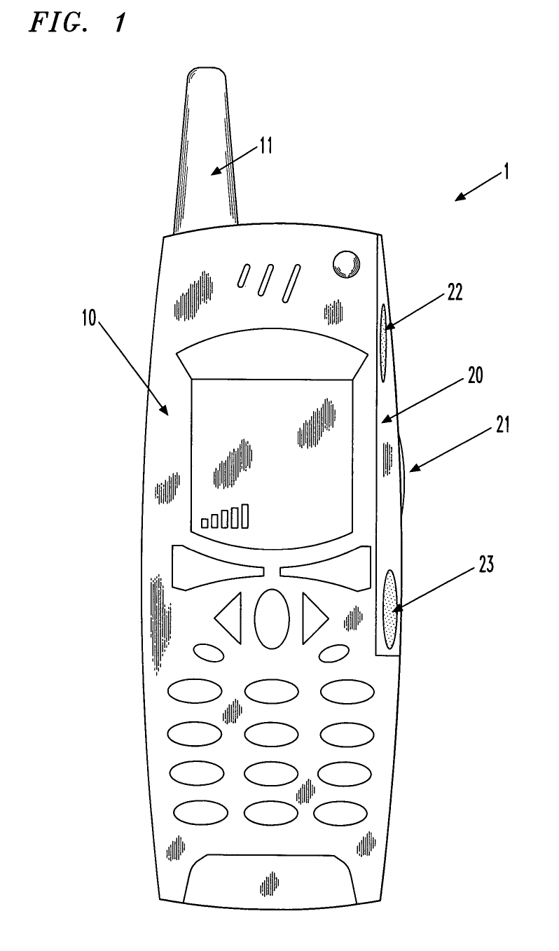

Referring first to FIG. 1 as an exemplary communication subscriber device according to the invention, a mobile telephone 1 incorporating the inventive detachable audio/speaking unit 20 is schematically depicted. The mobile telephone basic unit 10 (one type of subscriber basic unit) of the mobile telephone 1 has an antenna 11 for providing a transmitting/receiving functionality with regard to the subscriber communication device of a third party. A loudspeaker 22 and a microphone 23 are integrated within the detachable audio/speaking unit 20.

Furthermore, the detachable audio/speaking unit 2 is provided with an own short-range radio link transmitter/receiver entity 21 for the communication between the audio/speaking unit 20 and the mobile telephone basic unit 10 in particular when the audio/speaking unit is detached. Since the transmission functionality has to be designed only for such a short-range link the radio power level needs to be only very small. Accordingly, depending on specific applications, the provisions of Bluetooth interfaces may be used for such a short-range radio link communication between the mobile telephone basic unit 10. However, as an alternative and depending on specific correspondingly adapted embodiments, even a communication via the antenna 11 is possible between the basic unit 10 and the audio/speaking unit 20.

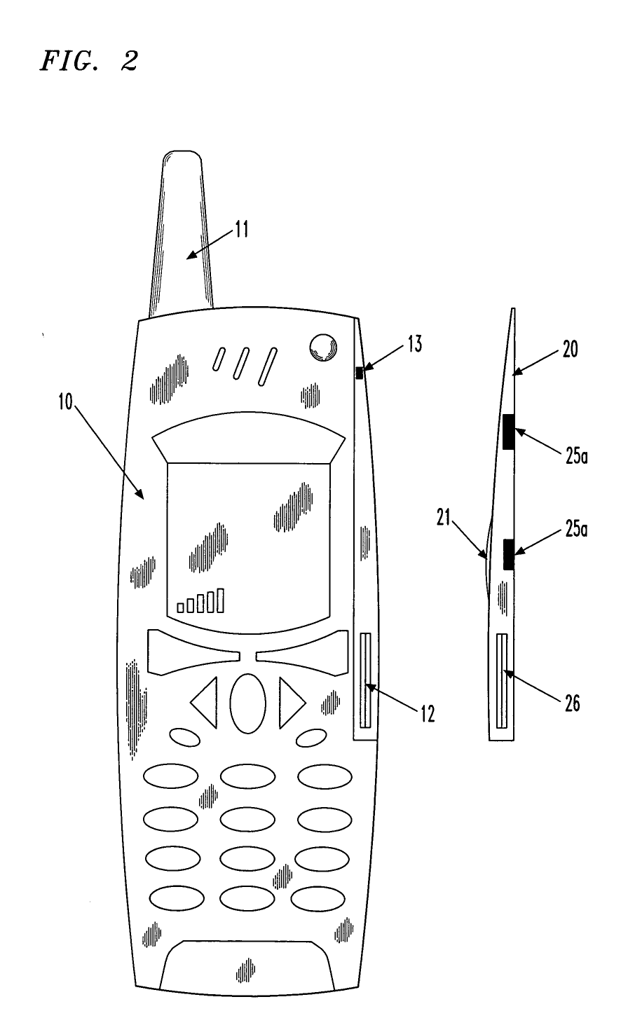

FIG. 2 illustrates the inventive audio/speaking unit 20 in a detached condition with regard to the mobile telephone basic unit 10. Complementary interengaging means 12 and 26 for electrically connecting both units together are integrated within each of the units 10 and 20. According to a preferred refinement, the communication, i.e., the speech and/or data transfer, between the audio/speaking unit 20 and the mobile telephone basic unit 10 during an attached condition is managed via the electrically interengaging means 12 and 26.

Additionally, for the mechanical connection of the two units 10 and 20 complementary mechanically interengaging means 13 and 28 are provided, ensuring, for example, a snap-on mounting or latching functionality for attaching the audio unit 20 to the mobile telephone basic unit 10.

Within a battery compartment 24 of the detachable audio/speaking unit 20 a small battery for providing the audio/speaking unit's energy supply can be inserted.

Preferably the electrical interfaces 12 and 26 are moreover adapted and coupled with the components of mobile telephone basic unit 10 and the audio unit 20 such that a chargeable battery inserted within the battery compartment 24 will be charged from and with the mobile telephone basic unit 10 if when the audio unit 20 is attached.

Due to the electrical connections provided by the interengaging interfaces 12 and 26, the functionality of the microphone 23 and the speaker 22 of the audio/speaking unit 20 are illustrated as being integrated within the mobile telephone 1 such as it would be by directly or usually incorporating a microphone and the speaker within the mobile telephone basic unit. Accordingly, most of the hardware, in particular the microphone 23, speaker 22 and a charging station needs to provided only once.

Moreover, in particular in case the mobile telephone basic unit 10 is adapted to be speech controllable this can be done even via the detached audio unit by means of the integrated microphone 23. However, the audio unit 20 may be provided in addition or as an alternative with an separate call control means, such as for example a specific bottom for controlling an incoming or originated call by a corresponding activation.

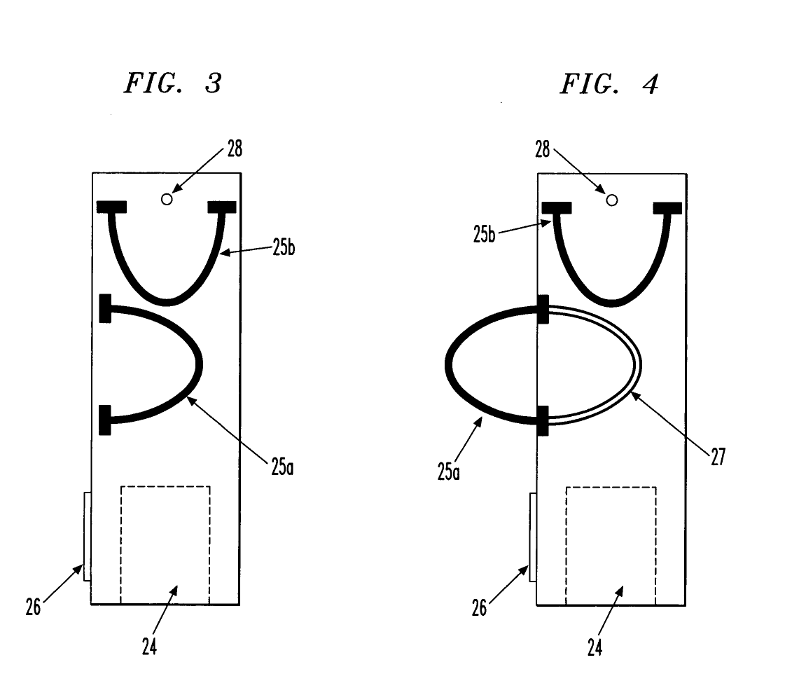

As can be seen from FIGS. 3 and 4, the exemplary audio unit 2 is provided with clip-like mounting means 25a and 25b to attach the detached audio/speaking unit 2 at the ear or to the closing of the user to keep the hands free during the use of it. A depression 27 corresponding to the clip 25a is formed at the audio/speaking unit 20 such that the clip 25a can be retracted in the audio/speaking unit 20 in attached condition of said unit or if the clip 25a is not in use.

It should be mentioned however, that the specific design and construction of an inventive audio/speaking unit may be realized in a multiple of different specific embodiments and may be constructed, for example, as an extendible and collapsible-unit instead of a rigid unit.

Although the present invention has been described in detail, those skilled in the art should understand that they can make various changes, substitutions and alterations herein without departing from the spirit and scope of the invention in its broadest form.

1. A communication subscriber device, comprising:
a subscriber basic unit; and
an audio/speaking unit, detachably interengageable with said subscriber basic unit, that provides audio and speaking functionality for said subscriber basic unit.

2. The communication subscriber device as recited in claim 1 wherein a short-range wireless link allows communication between said subscriber basic unit and said audio/speaking unit.

3. The communication subscriber device as recited in claim 1 wherein said audio/speaking unit comprises an energy supply unit.

4. The communication subscriber device as recited in claim 1 wherein said subscriber basic unit comprises a charging station for said audio/speaking unit.

5. The communication subscriber device as recited in claim 1 wherein said subscriber basic unit and said audio/speaking unit have complementary interfaces for electrically connecting said subscriber basic unit and said audio/speaking unit together.

6. The communication subscriber device as recited in claim 1 wherein said audio/speaking unit is constructed as a single unit.

7. The communication subscriber device as recited in claim 1 wherein said audio/speaking unit has only one microphone and one loudspeaker.

8. The communication subscriber device as recited in claim 1 wherein said audio/speaking unit is constructed as a selected one of:
a hands-free kit, and
a headset.

9. The communication subscriber device as recited in claim 1 wherein said audio/speaking unit is rigid.

10. The communication subscriber device as recited in claim 1 wherein said communication subscriber device is a mobile telephone.

11. An audio/speaking unit, comprising:
a mechanical interface configured to allow said audio/speaking unit to be detachably interengageable with a subscriber basic unit;
an electrical interface configured to communicate with said subscriber basic unit; and
a microphone and a loudspeaker coupled to said electrical interface and configured to provide audio and speaking functionality for said subscriber basic unit.

12. The audio/speaking unit as recited in claim 11 wherein said electrical interface comprises a short-range wireless link that allows communication between said subscriber basic unit and said audio/speaking unit.

13. The audio/speaking unit as recited in claim 11 wherein said audio/speaking unit comprises an energy supply unit.

14. The audio/speaking unit as recited in claim 11 wherein said audio/speaking unit derives power from a charging station of said subscriber basic unit.

15. The audio/speaking unit as recited in claim 11 wherein said audio/speaking unit is constructed as a single unit.

16. The audio/speaking unit as recited in claim 11 wherein said audio/speaking unit has only one microphone and one loudspeaker.

17. The audio/speaking unit as recited in claim 11 wherein said audio/speaking unit is constructed as a selected one of:
a hands-free kit, and
a headset.

18. The audio/speaking unit as recited in claim 11 wherein said audio/speaking unit is rigid.

19. The audio/speaking unit as recited in claim 11 wherein said communication subscriber device is a mobile telephone.
